(19) United States
(12) Patent Application Publication
(10) Pub. No.: US 2024/0330022 A1
(43) Pub. Date: Oct. 3, 2024

(54) METHOD FOR DISPLAYING INFORMATION, ELECTRONIC DEVICE, AND STORAGE MEDIUM

(71) Applicant: Beijing Dajia Internet Information Technology Co., Ltd., Beijing (CN)

(72) Inventors: Mengxin Han, Beijing (CN); Yanxin Zhao, Beijing (CN); Shiqiang Zhao, Beijing (CN); Na Li, Beijing (CN); Hailan Xu, Beijing (CN)

(21) Appl. No.: 18/536,503

(22) Filed: Dec. 12, 2023

(30) Foreign Application Priority Data
Mar. 27, 2023 (CN) 202310317732.2

(51) Int. Cl. G06F 9/451; G06Q 50/10; H04N 21/2187

(52) U.S. Cl. CPC G06F 9/451; G06Q 50/10; H04N 21/2187

(57) ABSTRACT

A method for displaying information includes: displaying, on a preset startup page, a multimedia resource corresponding to a target service party and page display trigger information corresponding to an associated detail page of the multimedia resource; and displaying at least one piece of service party information of the target service party on the preset startup page during a process of displaying the multimedia resource, in which the at least one piece of service party information is configured to trigger a display of at least one associated page of the target service party.

### CROSS REFERENCE TO RELATED APPLICATIONS

This application is based on and claims priority to Chinese patent application No. 202310317732.2, filed on Mar. 27, 2023, the content of which is incorporated herein by reference.

### TECHNICAL FIELD

The present disclosure relates to a field of Internet technologies, and particularly to a method for displaying information, an electronic device and a storage medium.

### BACKGROUND

With development of Internet technologies, various network information is widely spread, so that people may acquire various kinds of information quickly and timely, which provides a great convenience for people's life and work.

### SUMMARY

According to a first aspect of embodiments of the present disclosure, a method for displaying information is provided, and includes:
displaying, on a preset startup page, a multimedia resource corresponding to a target service party and page display trigger information corresponding to an associated detail page of the multimedia resource; and
displaying at least one piece of service party information of the target service party on the preset startup page during a process of displaying the multimedia resource, in which the at least one piece of service party information is configured to trigger a display of at least one associated page of the target service party.

According to a second aspect of embodiments of the present disclosure, an electronic device is provided, and includes: a processor; a memory configured for storing instructions executable by the processor; in which the processor is configured to execute the instructions to implement:
displaying, on a preset startup page, a multimedia resource corresponding to a target service party and page display trigger information corresponding to an associated detail page of the multimedia resource; and
displaying at least one piece of service party information of the target service party on the preset startup page during a process of displaying the multimedia resource, in which the at least one piece of service party information is configured to trigger a display of at least one associated page of the target service party.

According to a third aspect of embodiments of the present disclosure, a computer-readable storage medium is provided, in which, when executed by a processor of the electronic device, instructions in the storage medium cause an electronic device to perform:
displaying, on a preset startup page, a multimedia resource corresponding to a target service party and page display trigger information corresponding to an associated detail page of the multimedia resource; and
displaying at least one piece of service party information of the target service party on the preset startup page during a process of displaying the multimedia resource, in which the at least one piece of service party information is configured to trigger a display of at least one associated page of the target service party.

It should be noted that, the details above and in the following are exemplary and illustrative, and do not constitute the limitation on the present disclosure.

### BRIEF DESCRIPTION OF THE DRAWINGS

The drawings herein are incorporated into the specification and constitute a part of the specification, show embodiments in conformity with embodiments of the present disclosure, and explain the principle of the present disclosure together with the specification, and do not constitute an incorrect limitation of the present disclosure.

FIG. 1 is a flowchart illustrating a method for displaying information according to an exemplary embodiment.

FIG. 2 is a schematic diagram illustrating a change of a preset startup page during a process of displaying a multimedia resource according to an exemplary embodiment.

FIG. 3 is a schematic diagram illustrating a page during a process of displaying at least one piece of service party information according to an exemplary embodiment.

FIG. 4 is a schematic diagram illustrating a change of a preset startup page during another process of displaying a multimedia resource according to an exemplary embodiment.

FIG. 5 is a schematic diagram illustrating a preset startup page for displaying at least one piece of service party information and countdown information corresponding to to-be-started service information according to an exemplary embodiment.

FIG. 6 is a schematic diagram illustrating a preset startup page for displaying second page entry information according to an exemplary embodiment.

FIG. 7 is a schematic diagram illustrating a change of a preset startup page during another process of displaying a multimedia resource according to an exemplary embodiment.

FIG. 8 is a schematic diagram illustrating a preset startup page for displaying object description information according to an exemplary embodiment.

FIG. 9 is a schematic diagram illustrating a change of a preset startup page for displaying at least one piece of service party information in a style of a hovering card according to an exemplary embodiment.

FIG. 10 is a schematic diagram illustrating a change of a page during a service conversion process based on a preset startup page according to an exemplary embodiment.

FIG. 11 is a block diagram illustrating an apparatus for displaying information according to an exemplary embodiment.

FIG. 12 is a block diagram illustrating an electronic device for displaying information according to an exemplary embodiment.

### DETAILED DESCRIPTION

In order to make those skilled in the art better understand the technical solution of the present disclosure, the technical solution in embodiments of the present disclosure will be described clearly and completely in combination with the appended drawings in embodiments of the present disclosure.

It needs to be noted that, the “first”, “second” or similar words used in the present summary and the appended claims are configured only to distinguish similar objects, rather than describe a specific order or a precedence order. It should be understood that the data used herein may be interchanged where appropriate so that the embodiments of the present disclosure described herein may be implemented in an order other than illustrated or described herein. The implementations described in the following exemplary embodiments do not represent all implementations consistent with the present disclosure. Rather, they are merely examples of apparatuses and methods consistent with some aspects of the disclosure as detailed in the appended claims.

It should be noted that user information (including but not limited to user equipment information and user personal information) and data (including but not limited to displayed data and analyzed data) involved in the present disclosure are information and data authorized by a user or fully authorized by each party.

In the related art, in a startup process of some applications, in order to enrich startup pages of the applications and enhance interest of users in a waiting process, pictures, videos and other multimedia resources of some service parities and page display trigger information corresponding to associated detail pages of the multimedia resources may be displayed to the users through the startup pages, to recommend items related to service parties. The users may display trigger information through the pages to trigger a display of the associated details pages to achieve service conversion. However, in the related art, information displayed on the startup pages is relatively limited, and an effect of the service conversion is poor, which further leads to a large number of invalid recommendations for the multimedia resources, resulting in waste of system resources and reduction of system performance.

A method for displaying information provided in embodiments of the disclosure may be performed by a terminal. Optionally, the terminal may include, but is not limited to, a smart phone, a smart speaker, a digital assistant, an augmented reality (AR)/virtual reality (VR) device, a smart wearable device and other types of electronic devices, and may also be software running on the above electronic devices, such as an application program, etc. Optionally, an operating system running on the electronic device may include, but is not limited to, an Android system, an IOS system, Linux and Windows, etc.

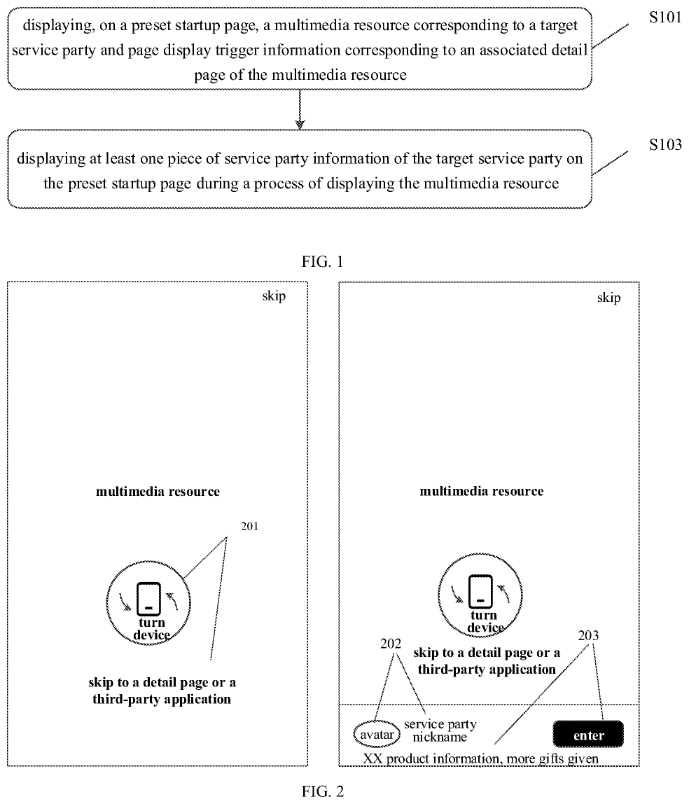

FIG. 1 is a flowchart illustrating a method for displaying information according to an exemplary embodiment. As illustrated in FIG. 1, the method may include the following steps.

At step S101, a multimedia resource corresponding to a target service party and page display trigger information corresponding to an associated detail page of the multimedia resource are displayed on a preset startup page.

In a specific embodiment, the preset startup page may be a startup page in a preset application program or a preset network platform. The preset startup page may be a display page of the multimedia resource. Specifically, the preset application program may be an application program capable of recommending the multimedia resource. Optionally, the preset application program may further publish the multimedia resource, etc. The preset network platform may be a network platform capable of recommending the multimedia resource. Optionally, the preset network platform may further publish the multimedia resource, etc.

In a specific embodiment, taking the preset startup page being the startup page in the preset application program as an example, in response to triggering startup of the preset application program, the multimedia resource and the page display trigger information corresponding to the associated detail page of the multimedia resource may be displayed on the preset startup page. Specifically, the multimedia resource corresponding to the target service party may be a multimedia content for introducing a service object associated with the target service party. For example, the multimedia content may be a static media content such as a picture, or may be a dynamic media content such as a video. The target service party may be a provider of a recommended object (a service object) corresponding to the multimedia resource.

In actual applications, the display of the associated detail page may be triggered through an operation on the preset startup page, alternatively, the display of the associated detail page may be further triggered through an operation on the device during the process of displaying the multimedia resource. Correspondingly, the page display trigger information may be information indicating a trigger mode of a display of the associated detail page, and for example, “click a page to skip to an associated detail page” (a trigger mode of triggering the display of the associated detail page through the operation on the preset startup page), or “turn a device to skip to an associated detail page” (a trigger mode of triggering the display of the associated detail page through the operation on the device during the process of displaying the multimedia resource), or “shake a device to skip to an associated detail page” (a trigger mode of triggering the display of the associated detail page through the operation on the device during the process of displaying the multimedia resource), etc.

In a specific embodiment, the page display trigger information corresponding to the associated detail page of the multimedia resource may be displayed synchronously with the multimedia resource, or may be displayed after the multimedia resource is displayed for a certain duration.

At step S103, the at least one piece of service party information of the target service party is displayed on the preset startup page during the process of displaying the multimedia resource.

In a specific embodiment, the at least one piece of service party information may be configured to trigger a display of at least one associated page of the target service party. Specifically, the at least one piece of service party information may be introduction information associated with the at least one target service party, for example, information introducing the target service party itself, information introducing the service object associated with the target service party, and information introducing a service project held by the target service party. Any one piece of service party information corresponds to one associated page. Optionally, different pieces of service party information may correspond to different associated pages, or two or more pieces of service party information may correspond to a same associated page.

In a specific embodiment, the at least one piece of service party information may be displayed synchronously with the multimedia resource, or may be displayed after the multimedia resource is displayed for a certain duration.

In an optional embodiment, the at least one piece of service party information may include at least one piece of general service party information and/or at least one piece of custom service party information; and correspondingly, displaying the at least one piece of service party information of the target service party on the preset startup page may include:
displaying the at least one piece of general service party information and/or the at least one piece of custom service party information on the preset startup page.

In actual applications, a service party that desires to put the multimedia resource on the preset application program or the preset network platform often registers an account on the preset application program or the preset network platform in advance. Specifically, the at least one piece of general service party information may be at least one piece of general account information of the target service party, such as an avatar and a nickname, etc. Optionally, the associated page corresponding to the general service party information such as the avatar and the nickname may be a service party homepage of the target service party. A display of the service party homepage may be triggered by clicking the avatar or the nickname. Specifically, the at least one piece of custom service party information may be service party information configured by the target service party for a current process of displaying the multimedia resource. Specifically, the custom service party information may be set in combination with actual application requirements. Optionally, the at least one piece of custom service party information may include custom service party information associated with the multimedia resource, and correspondingly, the associated page corresponding to the custom service party information associated with the multimedia resource may be the associated detail page of the multimedia resource. Specifically, for example, the multimedia resource introduces a certain product (a service object) of the target service party, the at least one piece of custom service party information includes information introducing the product. Optionally, the display of the corresponding associated page (the associated detail page) may be triggered by clicking an area where “information introducing the product” is located. Optionally, the custom service party information such as “information introducing the product” may further include corresponding page entry information, and correspondingly, the display of the corresponding associated page (the associated detail page) may be triggered by clicking the page entry information. Specifically, the at least one piece of custom service party information may include custom service party information not associated with the multimedia resource. For example, the multimedia resource introduces a certain product 1 of the target service party, and the custom service party information not associated with the multimedia resource may be information introducing another product 2 of the target service party. Optionally, a display of a corresponding associated page (a page corresponding to the product 2) may be triggered by clicking an area where “information introducing the product 2 of the target service party” is located. Optionally, the custom service party information such as “information introducing the product 2 of the target service party” may further include corresponding page entry information, and correspondingly, the display of the corresponding associated page (the page corresponding to the product 2) may be triggered by clicking the page entry information.

In a specific embodiment, taking displaying the multimedia resource and the page display trigger information first and then displaying the at least one piece of general service party information and the at least one piece of custom service party information as an example, as illustrated in FIG. 2, FIG. 2 is a schematic diagram illustrating a change of a preset startup page during a process of displaying a multimedia resource according to an exemplary embodiment. Specifically, in combination with figure a in FIG. 2, the preset startup page displays the multimedia resource and the page display trigger information, and the page display trigger information may include information corresponding to 201. Further, when the multimedia resource is displayed for a certain duration, as shown in figure b in FIG. 2, the preset startup page displays the at least one piece of service party information, and the at least one piece of general service party information in the at least one piece of service party information may include an avatar and a service party nickname corresponding to 202, and the at least one piece of custom service party information in the at least one piece of service party information may include information corresponding to 203.

In the above embodiment, in a case that the at least one piece of general service party information is taken as the service party information, presentation of service party information may be added, and an effect of service conversion may be improved without adding an additional material cost. In a case that the at least one piece of custom service party information is taken as the service party information, flexibility and diversity of the service party information may be improved, and further diversified conversion demands of the service party may be satisfied.

In an optional embodiment, the at least one piece of service party information may include at least one piece of general service party information and at least one piece of custom service party information; and optionally, displaying the at least one piece of service party information of the target service party on preset startup page may include:
displaying the at least one piece of general service party information on the preset startup page; and
in response to a display duration of the at least one piece of general service party information reaching a first preset duration, displaying the at least one piece of custom service party information on the preset startup page.

In a specific embodiment, the first preset duration may be preconfigured in combination with actual application requirements. A style prominence degree corresponding to the at least one piece of custom service party information is greater than a style prominence degree corresponding to the at least one piece of general service party information. Specifically, the style prominence degree may represent a prominence degree of the corresponding service party information.

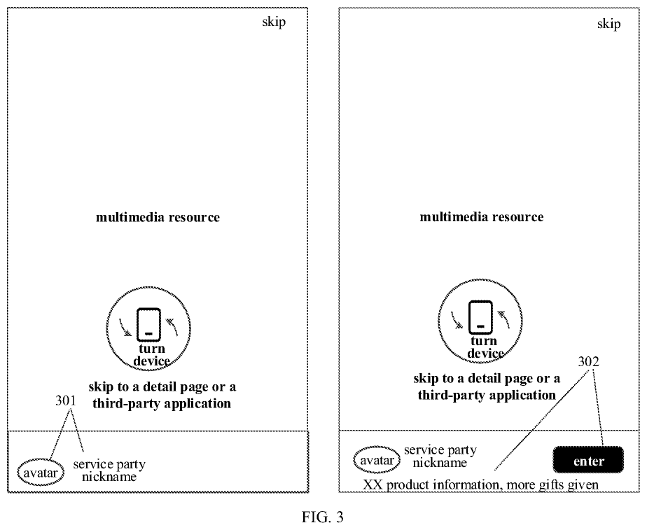

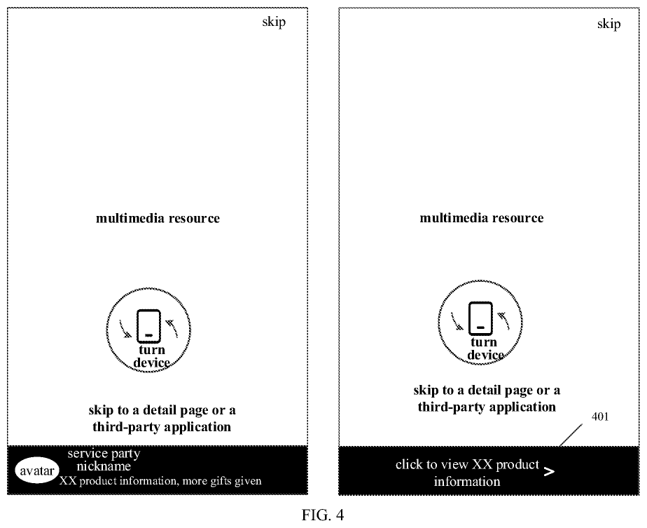

In a specific embodiment, as illustrated in FIG. 3, FIG. 3 is a schematic diagram illustrating a page during a process of displaying at least one piece of service party information according to an exemplary embodiment. Specifically, in combination with figure a in FIG. 3, the at least one piece of general service party information (information corresponding to 301) is displayed first. Then, in response to the display duration of the at least one piece of general service party information reaching the first preset duration, in combination with figure b in FIG. 3, the custom service party information (XX product information corresponding to 302) may be displayed.

In the above embodiment, with determining the at least one piece of general service party information and the at least one piece of custom service party information as the service party information, service party information may be enriched. With displaying the at least one piece of general service party information first, and displaying the at least one piece of custom service party information with the style prominence degree greater than the style prominence degree corresponding to the at least one piece of general service party information, the custom service information better may be highlighted, which may help the service party better recommend an associated page corresponding to the custom service party information.

In an optional embodiment, the at least one piece of service party information includes at least one piece of general service party information and at least one piece of custom service party information. Optionally, displaying the at least one piece of service party information of the target service party on preset startup page may include:
displaying the at least one piece of general service party information and the at least one piece of custom service party information on the preset startup page.

The method further includes: in response to a display duration of the at least one piece of general service party information and the at least one piece of custom service party information reaching a second preset duration, updating the at least one piece of general service party information and the at least one piece of custom service party information, displayed on the preset startup page information, to first page entry information corresponding to each of the at least one piece of custom service party information.

In a specific embodiment, the second preset duration may be preconfigured in combination with actual application requirements. The first page entry information corresponding to any one of the at least one piece of custom service party information is configured to trigger a display of an associated page corresponding to the any one of the at least one piece of custom service party information.

In a specific embodiment, as illustrated in FIG. 4, FIG. 4 is a schematic diagram illustrating a change of a preset startup page during another process of displaying a multimedia resource according to an exemplary embodiment. Specifically, in combination with figure a in FIG. 4, the service party information (including an avatar and a service party nickname both belonging to the general service party information, and XX product information belonging to the custom service party information) is displayed first. Then, in response to the display duration of the service party information reaching the second preset duration, in combination with figure b in FIG. 4, the service party information displayed on the first startup page may be updated to the first page entry information (information corresponding to 401) corresponding to each custom service party information (XX product information).

In addition, in actual applications, the at least one piece of service party information and the first page entry information may be displayed in combination with some dynamic effects to better highlight the service party information and a conversion entry corresponding to the custom service party information.

In the above embodiment, with determining the at least one piece of general service party information and the at least one piece of custom service party information as the service party information, service party information may be enriched. In response to the display duration of the at least one piece of general service party information and the at least one piece of custom service party information reaching the second preset duration, the at least one piece of general service party information and the at least one piece of custom service party information displayed on the preset startup page information are updated to the first page entry information corresponding to each of the at least one piece of custom service party information, which may highlight the conversion entry corresponding to the custom service information better and allow users more aware of a conversion destination corresponding to the custom service party information, thus helping the service party recommend an associated page corresponding to the custom service party information, enhancing an effect of service conversion, reducing invalid recommendations of multimedia resources, reducing waste of system resources, and improving system performance.

In an optional embodiment, in response to the at least one piece of service party information including to-be-started service information corresponding to the target service party, displaying the at least one piece of service party information of the target service party on the preset startup page includes:
displaying, on the preset startup page, the at least one piece of the service party information of target service party and countdown information corresponding to the to-be-started service information.

In a specific embodiment, the to-be-started service information may be introduction information of the service to be started corresponding to the target service party. The service to be started may be a service project held by the target service party, such as some promotion activities. The countdown information may be configured to indicate a start time of the service to be started corresponding to the to-be-started service information. In response to the at least one piece of service party information including the to-be-started service information corresponding to the target service party, the at least one piece of service party information may further include other introduction information associated with the target service party, for example, an avatar and a service party nickname of the target service party, etc.

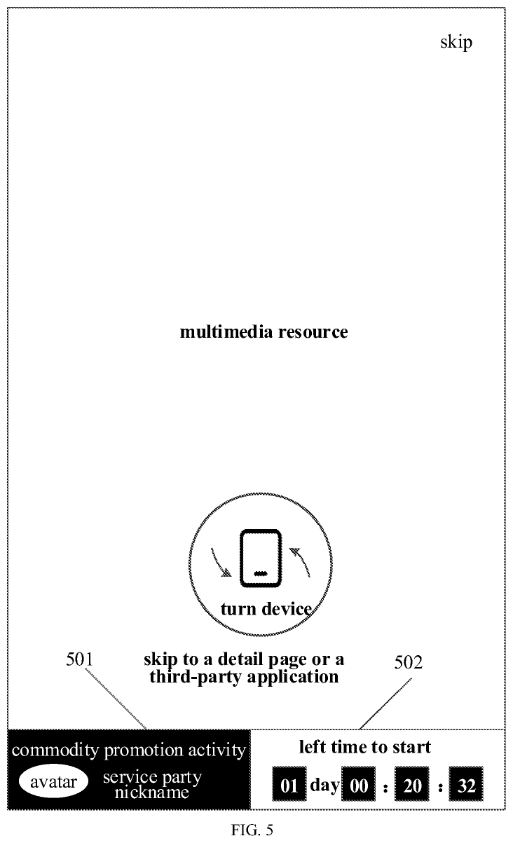

In a specific embodiment, as illustrated in FIG. 5, FIG. 5 is a schematic diagram illustrating a preset startup page for displaying at least one piece of service party information and countdown information corresponding to to-be-started service information according to an exemplary embodiment. Specifically, the at least one piece of service party information may include information corresponding to 501 (an avatar, a service party nickname and a commodity promotion activity). The commodity promotion activity may be the to-be-started service information, and information corresponding to 502 may be countdown information corresponding to the commodity promotion activity.

In the above embodiment, in response to the at least one piece of service party information including the to-be-started service information corresponding to the target service party, the countdown information corresponding to the to-be-started service information is displayed while the at least one piece of the service party information is displayed, which may help users clearly grasp the start time of the service to be started corresponding to the to-be-started service information, and further recommend the service to be started better, enhance an effect of service conversion, reduce invalid recommendations of multimedia resources, reduce waste of system resources, and improve system performance.

In an optional embodiment, the to-be-started service information belongs to the custom service party information, and in response to the at least one piece of service party information including the at least one piece of general service party information and the to-be-started service information, in order to highlight the to-be-started service information better, the at least one piece of general service party information in the at least one piece of service party information may be displayed first, and in response to the display duration of the at least one piece of general service party information reaching the first preset duration, the to-be-started service information and the countdown information corresponding to the to-be-started service information may be displayed on the preset startup page.

In an optional embodiment, the method may further include:
in response to a display duration of the at least one piece of service party information and the countdown information reaching a third preset duration, updating the at least one piece of service party information and the countdown information, displayed on the preset startup page, to second page entry information corresponding to the to-be-started service information;

In a specific embodiment, a third preset duration may be configured in combination with actual application requirements. Specifically, the second page entry information is configured to trigger a display of an associated page corresponding to the to-be-started service information, and the second page entry information includes the countdown information.

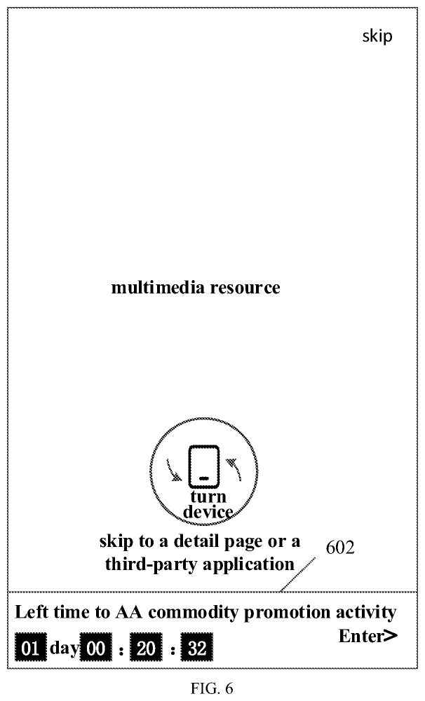

In a specific embodiment, as illustrated in FIG. 6, FIG. 6 is a schematic diagram illustrating a preset startup page for displaying second page entry information according to an exemplary embodiment. Specifically, information corresponding to 601 may be the second page entry information, such as, AA is a service party nickname.

In the above embodiment, in response to the display duration of the at least one piece of service party information and the countdown information reaching the third preset duration, the at least one piece of service party information and the countdown information displayed on the preset startup page are updated to the second page entry information corresponding to the to-be-started service information, which may highlight a conversion entry corresponding to the service to be started better and improve user's awareness of a conversion destination corresponding to to-be-started page information. The second page entry information includes the countdown information, the start time of the service to be started may be strengthened, which may further help the service party recommend the service to be started better, enhance an effect of service conversion, reduce invalid recommendations of multimedia resources, reduce waste of system resources, and improve system performance.

In an optional embodiment, the method may further include:
acquiring live streaming indication information corresponding to the target service party; and
in response to the live streaming indication information indicating that the target service party is in a live streaming state and a display duration of the at least one piece of service party information reaching a fourth preset duration, displaying, on the preset startup page, live streaming information corresponding to the target service party and live streaming entry information corresponding to the target service party.

In a specific embodiment, the live streaming information corresponding to the target service party may be configured to indicate whether the target service party is in the live streaming state. Specifically, the fourth preset duration may be configured in combination with actual application requirements. Specifically, the live streaming information may be information for describing a live streaming room corresponding to the target service party, such as indication information of the live streaming state and number of audiences in the live streaming room, and other information. The live streaming entry information may be information for triggering a display of a live streaming page corresponding to the target service party.

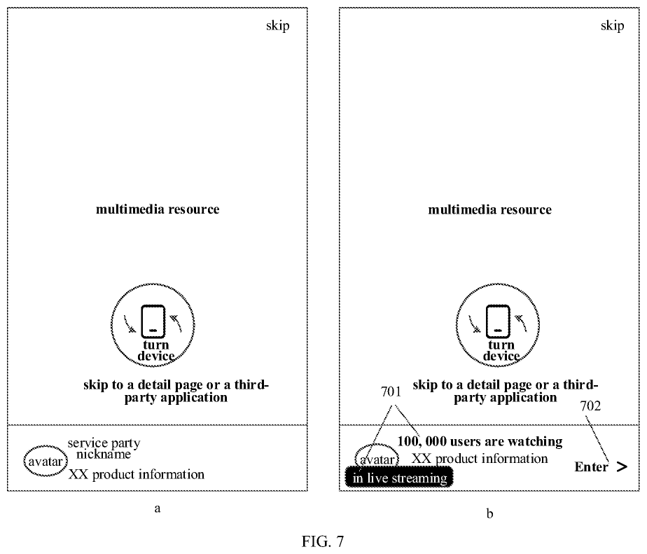

In a specific embodiment, as illustrated in FIG. 7, FIG. 7 is a schematic diagram illustrating a change of a preset startup page during another process of displaying a multimedia resource according to an exemplary embodiment. Specifically, in combination with figure a in FIG. 7, the service party information (an avatar, a service party nickname and XX product information) is displayed first. Then, in response to the display duration of the service party information reaching the fourth preset duration, the live streaming information corresponding to the target service party (information corresponding to 701) and the live streaming entry information corresponding to the target service party (information corresponding to 702) are displayed on the preset startup page.

Optionally, in response to the target service party being in the live streaming state, the live streaming page may be directly entered by clicking the avatar.

In addition, in actual applications, in the live streaming state, the display of the live streaming page may be triggered by means of clicking the service party information such as the avatar or an area where the service party information is located. Correspondingly, in order to simplify the page, the live streaming information may be displayed, and the live streaming entry information may not be displayed. Optionally, in response to the display duration of the live streaming information and the live streaming entry information reaching the fifth preset duration, the live streaming entry information may be hidden, and in response to the live streaming indication information indicating that the target service party is in the live streaming state and the display duration of the at least one piece of service party information reaching the fourth preset duration, the live streaming information may be directly displayed.

In the above embodiment, in response to the live streaming indication information indicating that the target service party is in the live streaming state and the display duration of the at least one piece of service party information reaching the fourth preset duration, the live streaming information corresponding to the target service party and the live streaming entry information corresponding to the target service party are displayed on the preset startup page, which may achieve recommendation of the live streaming room corresponding to the service party on the startup page, enrich the service party information better, and enhance diversity of information on the startup page.

In an optional embodiment, the live streaming information belongs to one piece of service party information. Optionally, in response to the live streaming indication information indicating that the target service party is in the live streaming state, the live streaming information may be displayed directly on the preset startup page. Correspondingly, in response to the at least one piece of service party information including other service party information, the live streaming information and the other service party information may be displayed on the preset startup page.

In an optional embodiment, the at least one piece of service party information may include object description information of a service object corresponding to the target service party; optionally, displaying the at least one piece of service party information of the target service party on the preset startup page may include:
displaying the object description information on the preset startup page.

In a specific embodiment, the object description information may be information for describing a service object. Optionally, the service object may be a product provided by the target service party. Optionally, the object description information may include resource credential information corresponding to the service object, and the resource credential information represents a resource amount consumed by the service object. Optionally, the object description information may further include a product name, a product model, and other information.

In a specific embodiment, in response to the at least one piece of service party information including the object description information of the service object corresponding to the target service party, the at least one piece of service party information may further include other introduction information associated with the target service party, such as an avatar and a service party nickname of the target service party, etc.

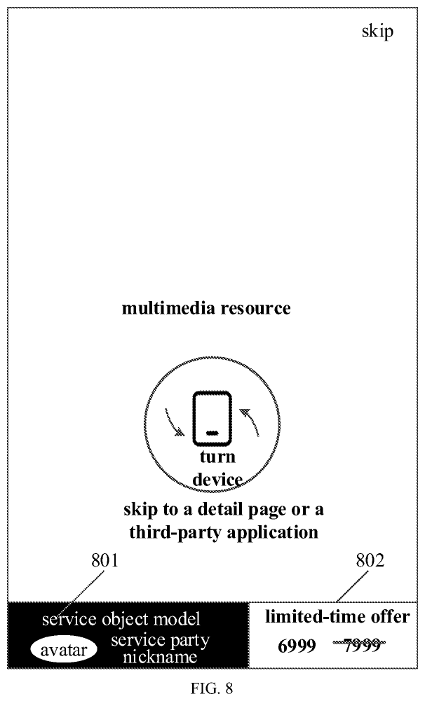

In a specific embodiment, as illustrated in FIG. 8, FIG. 8 is a schematic diagram illustrating a preset startup page for displaying object description information according to an exemplary embodiment. Specifically, the object description information may include a service object model corresponding to 801 and resource credential information corresponding to 802. Optionally, in combination with FIG. 8, the at least one piece of service party information may include the avatar, the service party nickname, etc.

In the above embodiment, with displaying on the preset startup page the object description information including the resource credential information corresponding to the service object, which may help users rapidly understand and acquire a resource amount consumed by the service object on the basis of enriching an information style, and further help the users decide whether to trigger the display of the corresponding associated page better.

In an optional embodiment, the object description information belongs to the custom service party information, and in response to the at least one piece of service party information including the at least one piece of general service party information and the object description information, in order to highlight the object description information better, the at least one piece of general service party information in the at least one piece of service party information may be displayed first, and in response to the display duration of the at least one piece of general service party information reaching the first preset duration, the object description information may be displayed on the preset startup page. Optionally, the at least one piece of general service party information and the object description information may be displayed on the preset startup page, and in response to the display duration of the at least one piece of custom service party information and the object description information reaching the second preset duration, the at least one piece of custom service party information and the object description information displayed on the preset startup page are updated to the page entry information corresponding to the object description information. The page entry information may be configured to trigger the display of the associated page corresponding to the object description information (such as a detail page corresponding to the service object, etc.).

In an optional embodiment, the at least one associated page may include the associated detail page, the page display trigger information may indicate to trigger a display of the associated detail page based on a preset three-dimensional operation. Specifically, the preset three-dimensional operation may be configured in combination with actual applications, such as shaking a device. Optionally, in combination with FIG. 2, the preset three-dimensional operation may be an operation of turning the device. Specifically, the service party information corresponding to the associated detail page indicates to trigger a display of the associated detail page based on a preset two-dimensional operation. The preset two-dimensional operation may be configured in combination with actual applications, such as a sliding operation. Optionally, in combination with figure b in FIG. 2, the preset two-dimensional operation may be an operation of clicking an “enter” control.

In the above embodiment, diversity of trigger modes and interest of interaction may be enhanced by triggering the display of the associated detail page based on a combination of the three-dimensional operation and the two-dimensional operation.

In an optional embodiment, displaying the at least one piece of service party information of the target service party on the preset startup page may include:
displaying the at least one piece of service party information in a style of a hovering card on the preset startup page.

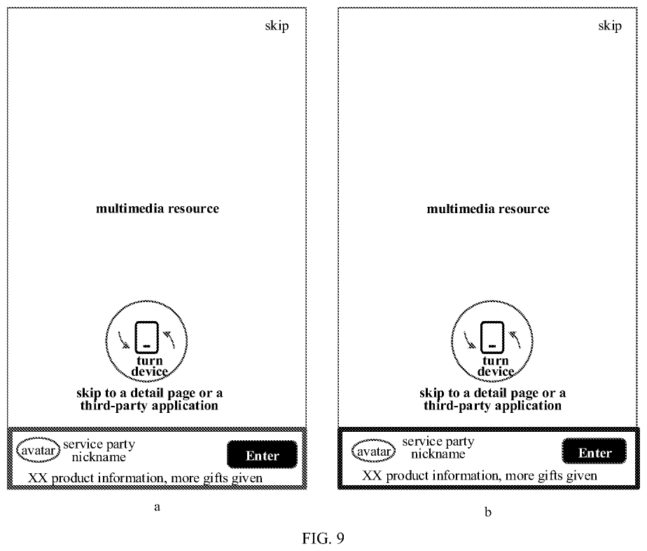

In a specific embodiment, during a process of displaying the at least one piece of service party information on the preset startup page, the style of the hovering card may change dynamically. As illustrated in FIG. 9, FIG. 9 is a schematic diagram illustrating a change of a preset startup page for displaying at least one piece of service party information in a style of a hovering card according to an exemplary embodiment. Specifically, in combination with figure a in FIG. 9, the hovering card may be presented by hovering at the bottom of the preset startup page, and in combination with figure b in FIG. 9, a bold frame at the edge of the preset startup page is added to focus on the service party information better.

In addition, in actual applications, the at least one piece of the service party information may be displayed in combination with some dynamic effects, such as the hovering card presented in jiggling, to highlight the service party information better.

In the above embodiment, the at least one piece of service party information in the style of the hovering card is displayed on the preset startup page, which may focus on the service party information better, further display the service party information better and enhance an effect of service conversion.

In an optional embodiment, in a scenario where the associated detail page is triggered to be displayed by turning the device, in response to a turning amplitude of the device being less than or equal to a preset amplitude, the hovering card and/or page entry information in the hovering card is controlled to turn based on the turning amplitude, to present a jiggling effect, which may further enhance interaction and interest during a process of displaying the page better. Optionally, in response to the turning amplitude of the device being greater than the preset amplitude, it is skipped to the associated detail page. Specifically, the preset amplitude may be preconfigured in combination with actual application requirements.

In another optional embodiment, in a case that a display trigger mode corresponding to the associated detail page is not turning the device, the hovering card and/or the page entry information in the hovering card may be controlled to turn based on the turning amplitude of the device in response to detecting that the device turns, to present the jiggling effect, and further enhance the interaction and the interest during the process of displaying the page better.

In an optional embodiment, in a case that playing the multimedia resource ends, it is skipped to a multimedia resource recommendation page. Optionally, a preset startup duration of the multimedia resource may be played on the preset startup page in combination with the preset startup duration, and a remaining part of the multimedia resource continues to be played after skipping to the multimedia resource recommendation page.

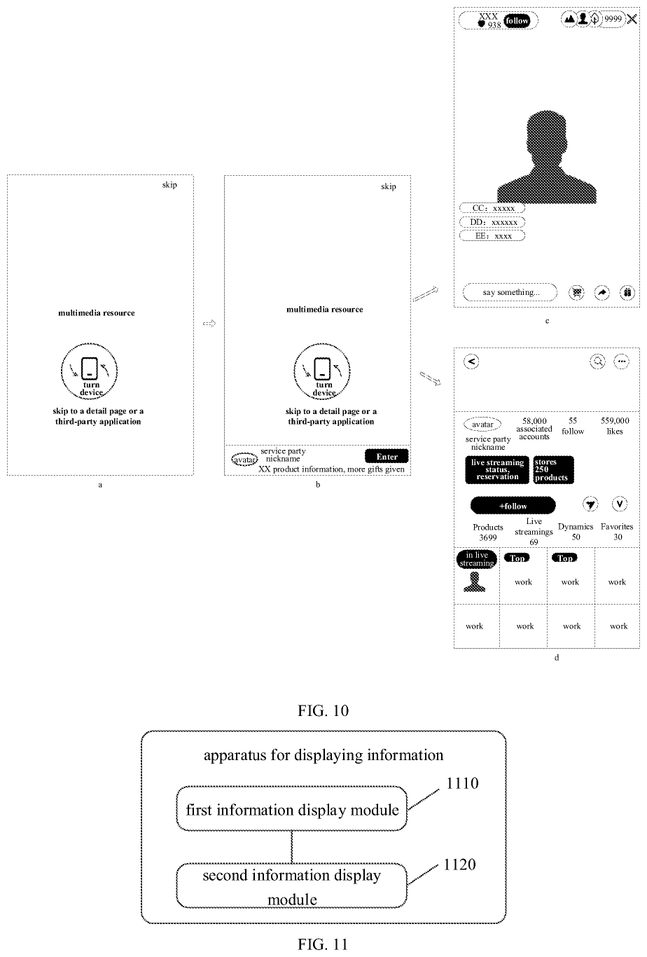

In a specific embodiment, as illustrated in FIG. 10, FIG. 10 is a schematic diagram illustrating a change of a page during a service conversion process based on a preset startup page according to an exemplary embodiment. Optionally, when a startup instruction of a preset application program or a preset network platform is triggered, in combination with figure a in FIG. 10, the multimedia resource corresponding to the target service party and the page display trigger information corresponding to the associated detail page of the multimedia resource may be displayed on the preset startup page. Optionally, after the multimedia resource is displayed for a certain duration, in combination with figure b in FIG. 10, the service party information of the target service party such as an avatar, a nickname and XX product information may be displayed on the preset startup page. Optionally, taking the XX product information being displayed in a live streaming mode as an example, when the user clicks an “enter” control as shown in figure b in FIG. 10, in combination with figure c in FIG. 10, it is skipped to an associated page corresponding to the XX product information (a live streaming page corresponding to the XX product information), to achieve promotion conversion of the XX product information. Optionally, when the user clicks the service party nickname as shown in figure b in FIG. 10, and the associated page corresponding to the service party nickname is a service party homepage corresponding to the target service party. Optionally, in combination with figure d in FIG. 10, it may be skipped to the service party homepage, to achieve recommendation conversion of the service party homepage and help the target service party achieve user undertaking from a public domain to a private domain. Optionally, when the user does not trigger skipping of the page during the process of displaying the service party information as shown in figure b in FIG. 10, it may be skipped to a page as shown in figure b in FIG. 7 in response to the display duration of the at least one piece of service party information reaching the fourth preset duration.

It can be seen from the technical solution provided in embodiments of the description, during a process of displaying recommendations of the multimedia resource corresponding to the target service party on the preset startup page, the at least one piece of service party information of the target service party may be displayed on the preset startup page on the basis of displaying the page display trigger information corresponding to the associated detail page of the multimedia resource, which may achieve presentation of more service party information and enrich display information of the startup page. The at least one piece of service party information is configured to trigger the display of the at least one associated page of the target service party, which allows users to trigger the display of the at least one associated page of the target service party on the basis of triggering the display of the associated detail page of the multimedia resource currently displayed based on the preset startup page, thus greatly improving a conversion range of the startup page, further improving an effect of service conversion, reducing invalid recommendation of multimedia resources, reducing waste of system resources, and improving system performance.

FIG. 10 is a block diagram illustrating an apparatus for displaying information according to an exemplary embodiment. In FIG. 11, the apparatus includes a first information display module 1110 and a second information display module 1120.

The first information display module 1110 is configured to perform displaying, on a preset startup page, a multimedia resource corresponding to a target service party and page display trigger information corresponding to an associated detail page of the multimedia resource.

The second information display module 1120 is configured to perform displaying at least one piece of service party information of the target service party on the preset startup page during a process of displaying the multimedia resource. The at least one piece of service party information is configured to trigger a display of at least one associated page of the target service party.

In an optional embodiment, the at least one piece of service party information includes at least one piece of general service party information and/or at least one piece of custom service party information; and the second information display module 1120 includes a first information display unit.

The first information display unit is configured to perform displaying the at least one piece of general service party information and/or the at least one piece of custom service party information on the preset startup page.

In an optional embodiment, the at least one piece of service party information includes at least one piece of general service party information and at least one piece of custom service party information.

The second information display module 1120 includes a second information display unit and a third information display unit.

The second information display unit is configured to perform displaying the at least one piece of general service party information on the preset startup page.

The third information display unit is configured to perform, in response to a display duration of the at least one piece of general service party information reaching a first preset duration, displaying the at least one piece of custom service party information on the preset startup page, in which, a style prominence degree corresponding to the at least one piece of custom service party information is greater than a style prominence degree corresponding to the at least one piece of general service party information.

In an optional embodiment, the at least one piece of service party information includes at least one piece of general service party information and at least one piece of custom service party information.

The second information display module 1120 includes a fourth information display unit.

The fourth information display unit is configured to perform displaying the at least one piece of general service party information and the at least one piece of custom service party information on the preset startup page.

In response to a display duration of the at least one piece of general service party information and the at least one piece of custom service party information reaching a second preset duration, the apparatus further includes a first information update module.

The first information update module is configured to perform updating the at least one piece of general service party information and the at least one piece of custom service party information, displayed on the preset startup page information, to first page entry information corresponding to each of the at least one piece of custom service party information;
the first page entry information corresponding to any one of the at least one piece of custom service party information is configured to trigger a display of an associated page corresponding to the any one of the at least one piece of custom service party information.

In an optional embodiment, in response to the at least one piece of service party information including service be started corresponding to the target service party, the second information display module 1120 includes a fifth information display unit.

The fifth information display unit is configured to perform displaying, on the preset startup page, the at least one piece of service party information of the target service party and countdown information corresponding to the to-be-started service information;
the countdown information is configured to indicate a start time of a service to be started corresponding to the to-be-started service information.

In an optional embodiment, the apparatus further includes a second information update module.

The second information update module is configured to perform, in response to a display duration of the at least one piece of service party information and the countdown information reaching a third preset duration, updating the at least one piece of service party information and the countdown information, displayed on the preset startup page, to second page entry information corresponding to the to-be-started service information;
the second page entry information is configured to trigger a display of an associated page corresponding to the to-be-started service information, and the second page entry information includes the countdown information.

In an optional embodiment, the apparatus further includes a live streaming indication information acquiring module and a third information display module.

The live streaming indication information acquiring module is configured to perform acquiring live streaming indication information corresponding to the target service party.

The third information display module is configured to perform displaying in response to the live streaming indication information indicating that the target service party is in a live streaming state and a display duration of the at least one piece of service party information reaching a fourth preset duration, displaying, on the preset startup page, live streaming information corresponding to the target service party and live streaming entry information corresponding to the target service party.

In an optional embodiment, the at least one piece of service party information includes object description information of a service object corresponding to the target service party, the object description information includes resource credential information corresponding to the service object, and the resource credential information represents a resource amount consumed by the service object; and the second information display module 1120 includes a sixth information display unit.

The sixth information display unit is configured to perform displaying the object description party information on the preset startup page.

In an optional embodiment, the at least one associated page includes the associated detail page, the page display trigger information indicates to trigger a display of the associated detail page based on a preset three-dimensional operation, and service party information corresponding to the associated detail page indicates to trigger a display of the associated detail page based on a preset two-dimensional operation.

In an optional embodiment, the second information display module 1120 includes a seventh information display unit.

The seventh information display unit is configured to perform displaying the at least one piece of service party information in a style of a hovering card on the preset startup page.

With regard to the apparatus in the above embodiments, the specific way in which each module performs the operation has been described in detail in the embodiments of the method and will not be elaborated here.

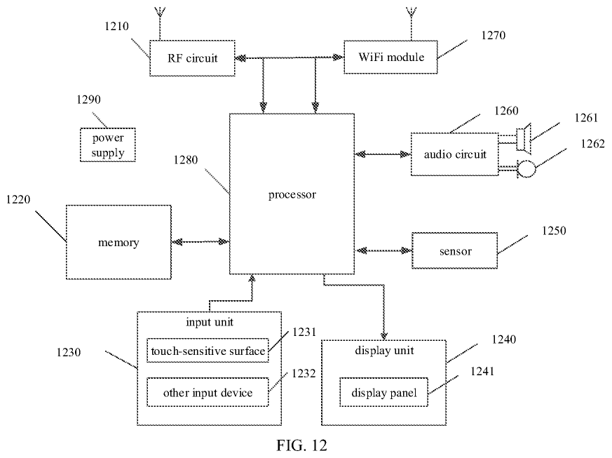

FIG. 12 is a block diagram illustrating an electronic device for displaying information according to an exemplary embodiment. The electronic device may be a terminal, and an internal structure diagram of the terminal may be illustrated in FIG. 12. The terminal may include a radio frequency (RF) circuit 1210, a memory 1220 including one or more computer-readable storage media, an input unit 1230, a display unit 1240, a sensor 1250, an audio circuit 1260, a wireless fidelity(Wi-Fi) module 1270, a processor 1280 including one or more processing cores, and a power supply 1290. Those skilled in the art will appreciate that the structure of the terminal illustrated in FIG. 12 does not constitute a limitation on the terminal, which may include more or fewer components than illustrated in Figure, or combining certain components, or different component arrangements.

The RF circuit 1210 may be configured to receive and send a signal during a process of receiving and sending information or a call, and specifically, downlink information of the base station is processed by one or more processors 1280 after being received; in addition, related uplink data are sent to the base station. Generally, the RF circuit 1210 includes but not limited to antennas, turners, one or more oscillators, user identity module (SIM) cards, transceivers, couplers, low noise amplifiers (LNA) and duplexers. In addition, the RF circuit 1210 may further communicate with networks and other terminal over wireless communication. The wireless communication may use any communication standard or protocol, including but not limited to a global system of mobile communication (GSM), a general packet radio service (GPRS), a code division multiple access (CDMA), a code division multiple access (CDMA), a wideband code division multiple access (WCDMA), a long term evolution (LTE), a short messaging service (SMS).

The memory 1220 may be configured to store software programs and modules, and the processor 1280 executes various functional applications and data processings by running a software program and a module stored in the memory 1220. The memory 1220 may include a program storage area and a data storage area; the program storage area may store operation systems and application programs required by a function; the data storage area may store data created based on the use of the terminal, etc. In addition, the memory 1220 may include a high-speed random access memory, and may also include a non-volatile memory, such as at least one magnetic disk storage device, a flash memory device, or other non-volatile solid-state storage devices. Correspondingly, the memory 1220 may further include a memory controller to provide access to the memory 1220 by the processor 1280 and the input unit 1230.

The input unit 1230 may receive input digital or character information, and generate keyboard, mouse, joystick, optical or trackball signal inputs related to a user configuration and function control. Specifically, the input unit 1230 may include a touch-sensitive surface 1231 and other input device 1232. The touch-sensitive surface 1231, also referred to as a touch display screen or a touchpad, may collect a touch operation of a user on or near the touch-sensitive surface 1231 (for example, an operation that a user uses any suitable object or accessory such as a finger or a touchpen to touch on the touch-sensitive surface 1231 or near the touch-sensitive surface 1231), and drives a corresponding connection device based on a preset program. Optionally, the touch-sensitive surface 1231 may include a touch detection device and a touch controller. The touch detection device detects a touch orientation of the user, detects a signal brought by the touch operation, and transmits the signal to a touch controller; and the touch controller receives touch information from the touch detection device, converts the touch information into contact coordinates, and sends the touch information to the processor 1280, and may receive and execute a command sent by the processor 1280. In addition, the touch-sensitive surface 1231 may be implemented in multiple types such as resistive, capacitive, infrared, and surface acoustic waves. In addition to the touch-sensitive surface 1231, the input unit 1230 may further include other input device 1232. Specifically, the other input device 1232 may include, but are not limited to, one or more of a function key (such as a volume control button, a switch button), a trackball, a mouse, an operating rod, and the like.

The display unit 1240 is may be configured to display information entered by the user, information provided to the user and various graphic user interfaces of the terminal. The graphic user interfaces may consist of graphics, texts, icons, videos and any combination thereof. The display unit 1240 may include a display panel 1241, and optionally, may configure the display panel 1241 in the form of a liquid crystal display (LCD), an organic light-emitting diode (OLED), etc. Further, the touch-sensitive surface 1231 may cover the display panel 1241, and when the touch-sensitive surface 1231 detects a touch operation on or near the touch-sensitive surface 1231, the touch operation is transmitted to the processor 1280 to determine a type of a touch event, and the processor 1280 provides a corresponding visual output on the display panel 1241 based on the type of the touch event. The touch-sensitive surface 1231 may be independent from the display panel 1241 to implement input and input functions, and in some embodiments, the touch-sensitive surface 1231 may also be integrated with the display panel 1241 to implement input and output functions.

The terminal may further include at least one sensor 1250, such as a light sensor, a motion sensor, and other sensors. Specifically, the light sensor may include an ambient light sensor and a proximity sensor. The ambient light sensor may adjust brightness of the display panel 1241 according to brightness of the ambient light, and the proximity sensor may turn off the display panel 1241 and/or backlight when the terminal moves to cars. As one of motion sensors, a gravity acceleration sensor may detect the magnitude of the acceleration in each direction (generally three-axis), the magnitude and direction of gravity when static, to recognize the application of the attitude of the terminal (such as horizontal and vertical screen switching, related game, magnetometer attitude calibration) and vibration recognition related functions (such as a pedometer, knock), etc.; and as for other sensors configurable by the terminal such as a gyroscope, a barometer, a hygrometer, a thermometer, an infrared sensor, which is not repeated here.

An audio circuit 1260, a speaker 1261, and a microphone 1262 may provide an audio interface between the user and the terminal. The audio circuit 1260 may transmit the electrical signal converted by the received audio data to the speaker 1261, and convert from the speaker 1261 to a sound signal for output by the speaker 1261; on the other hand, the microphone 1262 converts the collected sound signal to an electrical signal, receives by the audio circuit 1260 and then converts to the audio data, and processes by an audio data output processor 1280, and sends to another terminal via the RF circuit 1210, or to a memory 1220 for further processing. The audio circuit 1260 may further include an earplug jack to provide communication between a peripheral headset and the terminal.

Wi-Fi belongs to a short-range wireless transmission technology, and the terminal may help the user receive and transmit Email, browse web pages and access streaming media, etc., through the Wi-Fi module 1270, which provides wireless broadband Internet access for the user. Although FIG. 12 illustrates a Wi-Fi module 1270, it is to be understood that it is not a necessary composition of the terminal, and may be omitted entirely as desired without altering the essence of the invention.

The processor 1280, as a control center of the terminal, connects various components of the entire terminal through various interfaces and circuits, and runs or executes software programs and/or modules in the memory 1220 and calls data stored in the memory 1220 to execute various functions and processing data of the terminal, further to entirely monitor the terminal. Optionally, the processor 1280 may include one or more processing core; preferably, the processor 1280 may integrate an application processor and a modem processor. The application processor mainly deals with an operating system, a user interface and an application program, etc., and the modem processor mainly deals with wireless communication. It is understandable that the above modem may be not integrated in the processor 1280.

The terminal further includes a power source 1290 for powering various components, such as a battery, and preferably the power source may be logically connected to the processor 1280 through the power management system, thereby implementing functions such as charging, discharging, and power consumption management through the power management system. The power supply 1290 may further include one or more DC or AC power supplies, recharging systems, power failure detection circuits, power converters or inverters, power status indicators, and any other components.

The terminal not shown may be further a front camera, a Bluetooth module, etc., which is not be repeated here. Specifically, in the embodiment, the display unit of the terminal is a touch screen display, and the terminal further includes a memory and one or more programs, one or more of which are stored in the memory and configured to execute instructions in the method embodiments of the disclosure by one or more processors.

In an exemplary embodiment, an electronic device is further provided, and includes: a processor; a memory configured for storing instructions executable by the processor; the processor is configured to execute the instructions to implement the method for displaying information in embodiments of the disclosure.

In an exemplary embodiment, a computer-readable storage medium is further provided. Instructions in the storage medium cause an electronic device to perform the method for displaying information in embodiments of the disclosure when executed by a processor of the electronic device.

In an exemplary embodiment, a computer program product including instructions is further provided, and the computer program causes a computer to perform the method for displaying information in embodiments of the disclosure when running on the computer.

Those skilled in the art may understand that all or part of flows in the above method embodiments may be implemented by instructing relevant hardwares by a computer program. The computer program may be stored in a non-volatile computer-readable storage medium, and the computer program may include flows of the above method embodiments when being executed. Any reference to a memory, a storage, a database or other media used in embodiments provided in the application may include a non-volatile memory and/or a volatile memory. The non-volatile memory may include a read-only memory (ROM), a programmable ROM (PROM), an electrically programmable ROM (EPROM), an electrically erasable programmable ROM (EEPROM), or a flash memory. The volatile memory may include a random access memory (RAM) or an external cache memory. By way of illustration, the RAM may be obtained in various forms, such as a static RAM (SRAM), a dynamic RAM (DRAM), a synchronous DRAM (SDRAM), a dual data rate SDRAM (DDRSDRAM), an enhanced SDRAM (ESDRAM), a synchlink DRAM (SLDRAM), a memory bus (Rambus) direct RAM (RDRAM), a direct memory bus dynamic RAM (DRDRAM), and a memory bus dynamic RAM (RDRAM).

After considering the specification and practicing the disclosure here, those skilled in the art will easily think of other implementations. The present application is intended to cover any variations, usages, or adaptive changes of the present disclosure. These variations, usages, or adaptive changes follow the general principles of the present disclosure and include common knowledge or conventional technical means in the technical field not disclosed by the present disclosure. The description and the embodiments are to be regarded as exemplary only, and the true scope and spirit of the present disclosure are given by the appended claims.

It should be understood that the present disclosure is not limited to the precise structure described above and shown in the drawings, and various modifications and changes may be made without departing from its scope. The scope of the present application is only limited by the appended claims. The scope of the present application is only limited by the appended claims.

What is claimed is:

1. A method for displaying information, comprising:
displaying, on a preset startup page, a multimedia resource corresponding to a target service party and page display trigger information corresponding to an associated detail page of the multimedia resource; and
displaying at least one piece of service party information of the target service party on the preset startup page during a process of displaying the multimedia resource, wherein the at least one piece of service party information is configured to trigger a display of at least one associated page of the target service party.

2. The method according to claim 1, wherein the at least one piece of service party information comprises at least one piece of general service party information and/or at least one piece of custom service party information; and displaying the at least one piece of service party information of the target service party on the preset startup page comprises:
displaying the at least one piece of general service party information and/or the at least one piece of custom service party information on the preset startup page.

3. The method according to claim 1, wherein the at least one piece of service party information comprises at least one piece of general service party information and at least one piece of custom service party information; and displaying the at least one piece of service party information of the target service party on the preset startup page comprises:
displaying the at least one piece of general service party information on the preset startup page; and
in response to a display duration of the at least one piece of general service party information reaching a first preset duration, displaying the at least one piece of custom service party information on the preset startup page, wherein a style prominence degree corresponding to the at least one piece of custom service party information is greater than a style prominence degree corresponding to the at least one piece of general service party information.

4. The method according to claim 1, wherein the at least one piece of service party information comprises at least one piece of general service party information and at least one piece of custom service party information; and displaying the at least one piece of service party information of the target service party on the preset startup page comprises:
displaying the at least one piece of general service party information and the at least one piece of custom service party information on the preset startup page;
the method further comprises:
in response to a display duration of the at least one piece of general service party information and the at least one piece of custom service party information reaching a second preset duration, updating the at least one piece of general service party information and the at least one piece of custom service party information displayed on the preset startup page information to first page entry information corresponding to each of the at least one piece of custom service party information;
wherein the first page entry information corresponding to any one of the at least one piece of custom service party information is configured to trigger a display of an associated page corresponding to the any one of the at least one piece of custom service party information.

5. The method according to claim 1, wherein in response to the at least one piece of service party information comprising to-be-started service information corresponding to the target service party, displaying the at least one piece of service party information of the target service party on the preset startup page comprises:
displaying, on the preset startup page, the at least one piece of service party information of the target service party and countdown information corresponding to the to-be-started service information;
wherein the countdown information is configured to indicate a start time of a service to be started corresponding to the to-be-started service information.

6. The method according to claim 5, further comprising:
in response to a display duration of the at least one piece of service party information and the countdown information reaching a third preset duration, updating the at least one piece of service party information and the countdown information displayed on the preset startup page to second page entry information corresponding to the to-be-started service information;
wherein the second page entry information is configured to trigger a display of an associated page corresponding to the to-be-started service information, and the second page entry information comprises the countdown information.

7. The method according to claim 1, further comprising:
acquiring live streaming indication information corresponding to the target service party; and
in response to the live streaming indication information indicating that the target service party is in a live streaming state and a display duration of the at least one piece of service party information reaching a fourth preset duration, displaying, on the preset startup page, live streaming information corresponding to the target service party and live streaming entry information corresponding to the target service party.

8. The method according to claim 1, wherein the at least one piece of service party information comprises object description information of a service object corresponding to the target service party, the object description information comprises resource credential information corresponding to the service object, and the resource credential information represents a resource amount consumed by the service object; and displaying the at least one piece of service party information of the target service party on the preset startup page comprises:
displaying the object description information on the preset startup page.

9. The method according to claim 1, wherein the at least one associated page comprises the associated detail page, the page display trigger information indicates to trigger a display of the associated detail page based on a preset three-dimensional operation, and service party information corresponding to the associated detail page indicates to trigger a display of the associated detail page based on a preset two-dimensional operation.

10. The method according to claim 1, wherein displaying the at least one piece of service party information of the target service party on the preset startup page comprises:
displaying the at least one piece of service party information in a style of a hovering card on the preset startup page.

11. An electronic device, comprising:
a processor; and
a memory for storing instructions executable by the processor;
wherein the processor is configured to execute the instructions to implement:
displaying, on a preset startup page, a multimedia resource corresponding to a target service party and page display trigger information corresponding to an associated detail page of the multimedia resource; and
displaying at least one piece of service party information of the target service party on the preset startup page during a process of displaying the multimedia resource, wherein the at least one piece of service party information is configured to trigger a display of at least one associated page of the target service party.

12. The electronic device according to claim 11, wherein the at least one piece of service party information comprises at least one piece of general service party information and/or at least one piece of custom service party information; and the processor is configured to execute the instructions to implement:
displaying the at least one piece of general service party information and/or the at least one piece of custom service party information on the preset startup page.

13. The electronic device according to claim 11, wherein the at least one piece of service party information comprises at least one piece of general service party information and at least one piece of custom service party information; and the processor is configured to execute the instructions to implement:
displaying the at least one piece of general service party information on the preset startup page; and
in response to a display duration of the at least one piece of general service party information reaching a first preset duration, displaying the at least one piece of custom service party information on the preset startup page, wherein a style prominence degree corresponding to the at least one piece of custom service party information is greater than a style prominence degree corresponding to the at least one piece of general service party information.

14. The electronic device according to claim 11, wherein the at least one piece of service party information comprises at least one piece of general service party information and at least one piece of custom service party information; and the processor is configured to execute the instructions to implement:
displaying the at least one piece of general service party information and the at least one piece of custom service party information on the preset startup page;
the method further comprises:
in response to a display duration of the at least one piece of general service party information and the at least one piece of custom service party information reaching a second preset duration, updating the at least one piece of general service party information and the at least one piece of custom service party information displayed on the preset startup page information to first page entry information corresponding to each of the at least one piece of custom service party information;
wherein the first page entry information corresponding to any one of the at least one piece of custom service party information is configured to trigger a display of an associated page corresponding to the any one of the at least one piece of custom service party information.

15. The electronic device according to claim 11, wherein in response to the at least one piece of service party information comprising to-be-started service information corresponding to the target service party, the processor is configured to execute the instructions to implement comprises:
displaying, on the preset startup page, the at least one piece of service party information of the target service party and countdown information corresponding to the to-be-started service information;
wherein the countdown information is configured to indicate a start time of a service to be started corresponding to the to-be-started service information.

16. The electronic device according to claim 11, wherein the processor is configured to execute the instructions to further implement:
acquiring live streaming indication information corresponding to the target service party; and
in response to the live streaming indication information indicating that the target service party is in a live streaming state and a display duration of the at least one piece of service party information reaching a fourth preset duration, displaying, on the preset startup page, live streaming information corresponding to the target service party and live streaming entry information corresponding to the target service party.

17. The electronic device according to claim 11, wherein the at least one piece of service party information comprises object description information of a service object corresponding to the target service party, the object description information comprises resource credential information corresponding to the service object, and the resource credential information represents a resource amount consumed by the service object; and the processor is configured to execute the instructions to further implement:
displaying the object description information on the preset startup page.

18. The electronic device according to claim 11, wherein the at least one associated page comprises the associated detail page, the page display trigger information indicates to trigger a display of the associated detail page based on a preset three-dimensional operation, and service party information corresponding to the associated detail page indicates to trigger a display of the associated detail page based on a preset two-dimensional operation.

19. The electronic device according to claim 11, wherein displaying the at least one piece of service party information of the target service party on the preset startup page comprises:
displaying the at least one piece of service party information in a style of a hovering card on the preset startup page.

20. A computer-readable storage medium, wherein when executed by a processor of an electronic device, instructions in the storage medium cause the electronic device to perform:
displaying, on a preset startup page, a multimedia resource corresponding to a target service party and page display trigger information corresponding to an associated detail page of the multimedia resource; and
displaying at least one piece of service party information of the target service party on the preset startup page during a process of displaying the multimedia resource, wherein the at least one piece of service party information is configured to trigger a display of at least one associated page of the target service party.
